(19) United States
(12) Patent Application Publication
(10) Pub. No.: US 2021/0394316 A1
(43) Pub. Date: Dec. 23, 2021

(54) MULTI-HEAD FASTENING SYSTEMS FOR USE IN ROOFING INSTALLATIONS

(71) Applicant: Beldon Technologies Inc., San Antonio, TX (US)

(72) Inventors: Bradford Beldon, San Antonio, TX (US); Daniel Mendez, San Antonio, TX (US); James Goodwin, San Antonio, TX (US); Danny Mendez, San Antonio, TX (US)

(21) Appl. No.: 17/297,660

(22) PCT Filed: Nov. 27, 2019
(86) PCT No.: PCT/US19/63528

§ 371 Date: May 27, 2021

Related U.S. Application Data
(60) Provisional application No. 62/771,862, filed on Nov. 27, 2018.

(51) Int. Cl. B23P 19/06; E04D 15/00

(52) U.S. Cl. CPC B23P 19/069; E04D 15/00

(57) ABSTRACT

A system for installing multiple fasteners to a substrate comprising; a chassis having a frame and a transverse member; a plurality of fastener heads mounted to the transverse member; a fastener feed system; a fastener head actuator to move two or more fastener heads in simultaneous movement; and a control system having a processor configured to control movement of the fastener head actuator.

### CROSS-REFERENCE TO RELATED PATENT APPLICATIONS

This patent application claims a benefit of priority to U.S. Patent Application 62/771,862 filed on 27 Nov. 2018, which is herein incorporated by reference for all purposes.

### BACKGROUND

Modern practices in roofing installation include a number of different materials that are secured to the roof substrate. From weatherproofing to insulation to outer layers, one or more layers must be fastened to the roof. Fastening has previously been done by hand, using either screws, nails or brads in combination with washers or brackets. Attempts have been made in the past to partially automate the fastening process. For example, U.S. Pat. No. 5,584,415 discloses a device for dispensing stackable roofing washers individually and for driving fasteners through the washer and into the roof substrate. Further, the device disclosed therein did not offer any significant time savings over traditional hand installation or offer any other efficiencies. Likewise, the device disclosed therein, being manned by one operator, provided only slight improvements on installation speed. Additionally, the device disclosed therein does not decrease the number of operators needed over traditional hand installation. As such, a more automated device that installs multiple fasteners in the desired pattern on the roof would be advantageous in light of the high demand for skilled laborers.

The single shot roofing fastener experienced additional disadvantages. Indeed, the operator was required to manually load the fasteners into the device loading chamber, which resulted in frequent and persistent jamming of the fasteners. In addition, the device disclosed in U.S. Pat. No. 5,584,415 did not provide any tactile or quantitative feedback to allow the operator to determine if the fastener had been over or under torqued upon installation. Additionally, in the device disclosed in U.S. Pat. No. 5,584,415, the operator could not physically see the point of installation until after the device had been removed from the installation site. Also, in the device disclosed in U.S. Pat. No. 5,584,415, in order for the device to maintain alignment in the chamber, a retaining O-ring is used to keep the fastener perpendicular to the insulation board or roofing substrate. This O-ring expands when a downward force, into the plane of the substrate, is applied by the operator into the handle of the drill. The O-ring, being elastic can degrade over time, thereby negatively impacting alignment. Additionally, in the device disclosed in U.S. Pat. No. 5,584,415, the operator is required to apply a sufficient downward force in order for the driven fastener to penetrate the substrate, such as sheet metal.

### SUMMARY

Broadly, in some embodiments, an automated fastening device that overcomes at least some of these deficiencies is desirable. For example, a fully automated machine that is moveable about a roof would alleviate the need for a worker to exert a downward force on the device. Likewise, for example, multiple fastening heads that drive multiple fasteners into the substrate simultaneously would significantly reduce the time of installation and reduce the number of operators or laborers needed on any particular job site. Similarly, for example, an automated feed system would reduce jamming and operator prep time. Other advantages are apparent in the various embodiments disclosed herein.

In some embodiments, a roof fastening cart comprises a multi head system of seven drills. The cart can be operated by a controller giving the drill system a set patterns to be applied to the insulation board. This design is also made to save cost by beating the average human installation time. With the cart having similar components as the stand-up drill, such as the washer fastener, the design can be improved and can be more efficient than the stand-up drill. The multi-head, automated fastening system of this disclosure can improve accuracy during installation and can increase wind uplift for the roof.

In some embodiments, a system for installing multiple fasteners to a substrate comprises: a chassis having a frame and a transverse member; a plurality of fastener heads mounted to the transverse member; a fastener feed system; a fastener head actuator to move two or more fastener heads in simultaneous movement; and a control system comprising a processor configured to control movement of the fastener head actuator.

In other embodiments, a multi-head fastening device comprises a chassis having a frame with a longitudinal and transverse axis: a plurality of wheels secured to the frame; a transverse rail movable relative to the frame; a plurality of automated fastening heads mounted to the movable rail, wherein each fastening head is configured to automatically install a fastener to a substrate below the chassis and further configured to move vertically; a fastener loading mechanism; and a control system for activating the plurality of fastener heads.

In still other embodiments one or more of the following features may be included in any combination. A first servo motor moves the transverse rail and a second servo motor moves the plurality of fastening heads. The second servo motor comprises a plurality of servo motors. Each of the plurality of fastening heads has a dedicated servo motor and is configured to move independently from any other fastening head. A plurality of servo motors actuates movement of the transverse rail relative to the longitudinal axis of the frame and actuates movement of each of the plurality of fastener heads vertically from a plane defined by the longitudinal and transverse axis of the frame. An actuator feeds fasteners into each of the plurality of the fastener heads. The control system is configured to actuate two or more fastener heads simultaneously. The control system is configured to actuate two or more fastener heads independently. The control system is configured to actuate at least three fastener heads simultaneously in a first installation and to actuate at least two fastener heads in a second installation. A photo sensor determines the position of the plurality of fastener heads.

In a further still embodiment, a method of installing multiple fasteners to a substrate comprises the following steps. Providing a multi-head fastening device having a frame with a longitudinal and transverse axis, a plurality of wheels secured to the frame, a transverse rail movable relative to the frame, a plurality of automated fastening heads mounted to the movable rail with each fastening head configured to automatically install a fastener to a substrate below the chassis and further configured to move vertically, fastener loading mechanism; and a control system for activating the plurality of fastener heads. Then activating a first sequence wherein the control system causes a first set of the plurality of fastening heads to install multiple fasteners to a substrate at a first location. And also activating a second sequence wherein the control system causes a second set of the plurality of fastening heads to install multiple fasteners to a substrate at a second location.

### DESCRIPTION OF DRAWINGS

FIG. 1 represents a back view of an example embodiment of a multi-head roof fastening system according to this disclosure.

FIG. 2 represents a front view of an example embodiment of a multi-head roof fastening system according to this disclosure.

FIG. 3 represents a top view of an example embodiment of a multi-head roof fastening system according to this disclosure.

FIG. 4 represents a wiring diagram of an example embodiment of a multi-head roof fastening system according to this disclosure.

FIG. 5 represents a circuit diagram of an example embodiment of a multi-head roof fastening system according to this disclosure.

Note that the drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION OF PREFERRED EMBODIMENTS

Example embodiments of this disclosure comprise a multi-head fastening system for use in a roofing installation, such as for installing fasteners (e.g., nails, brads, screws, bolts) to a roofing substrate, whether in a residential, industrial, or commercial setting, whether the roofing substrate is level/flat or inclined, such as less than about 90 degrees. The system may be utilized with various roofing systems and roof substrates, such as sheet metals, woods, manufactured materials, or metal, wood, plastic, or rubber composites, or others. In one example embodiment, a moveable cart having a frame includes a plurality of drills (or nail or screw guns or other electrically or pneumatically or hydraulically powered instruments) that may be actuated individually (or in groups) according to control circuitry and programming, whether local or remote to the movable cart. The individual drills are automatically fed with fasteners through a feed mechanism (e.g., magazine-based, cartridge-based, belt-based). Servo motors (or other electric or hydraulic or pneumatic motors) control the vertical movement of each individual drill. The plurality of drills are arranged on a rack that moves horizontally along the cart via one or more additional servo motors (or other electric or hydraulic or pneumatic motors).

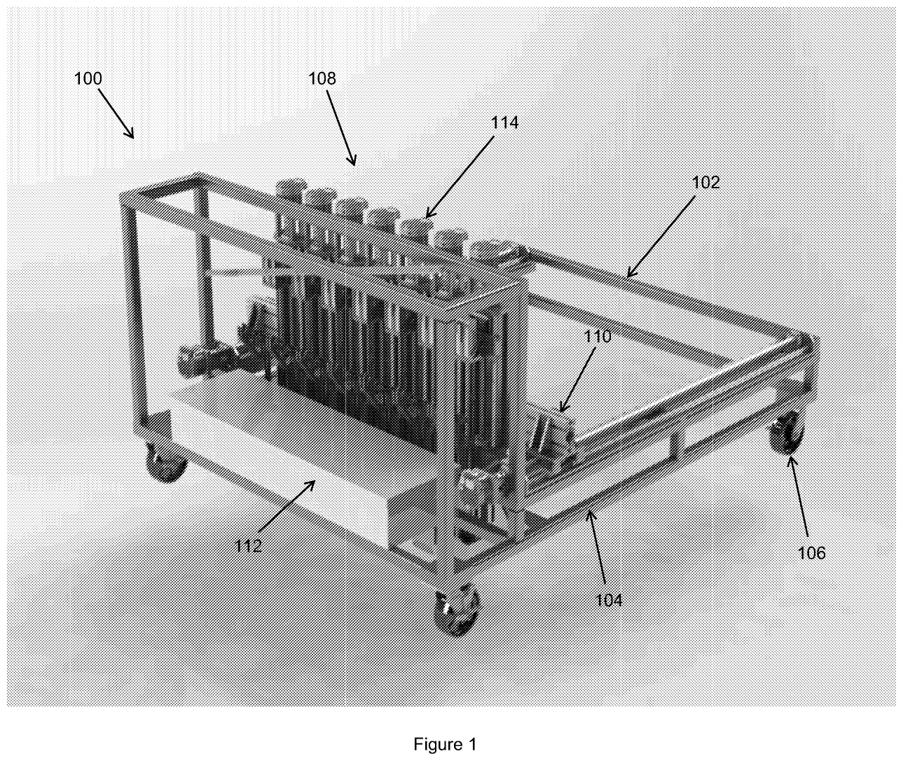

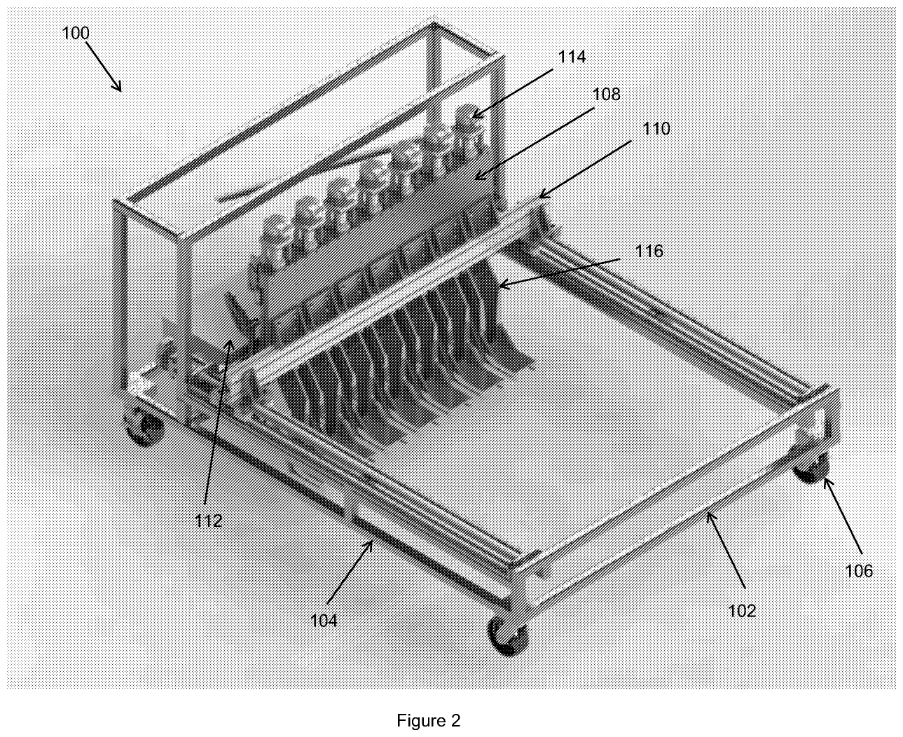

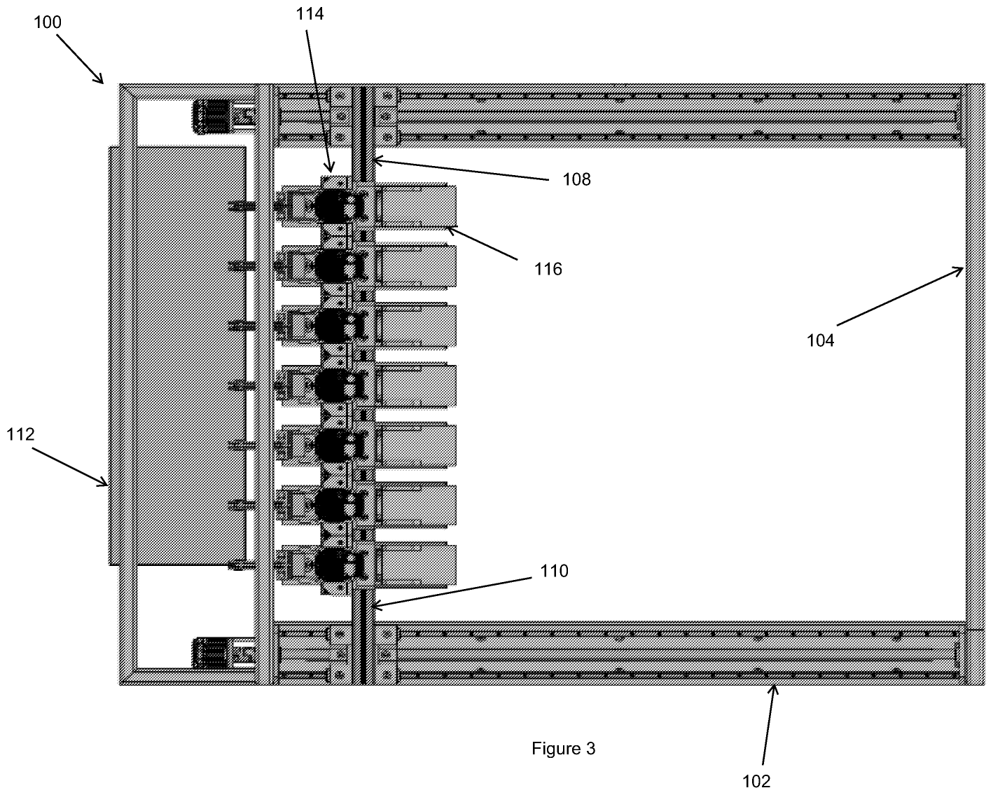

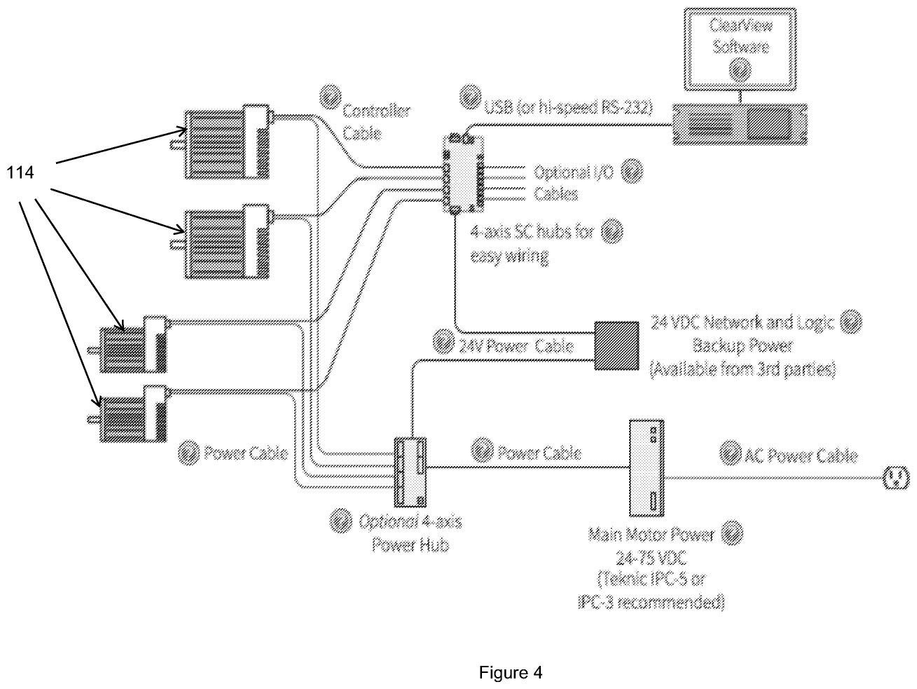

With reference to FIGS. 1-5, this disclosure further discloses an automated, multi-head, roofing fastener system 100. In the example embodiment depicted, the roofing fastener system 100 includes a chassis or cart 102 that provides a frame 104 (e.g., metal, plastic, wood, rubber) for the various components thereon. The frame 104 is rectangular in terms of perimeter, but can be non-rectangular as well (e.g., square, triangle, trapezoid, triangle, pentagon, hexagon, octagon, polygon), whether open-shaped or closed-shaped, whether symmetrical or asymmetrical. The cart 102 includes four (or more or less) caster wheels 106, though other arrangements that facilitate mobility are possible (e.g., rail tracks, continuous tracks, robotic articulating legs). The frame 104 may present a longitudinal axis for the cart 102 that is parallel (or non-parallel) to a multi fastener rack 108. The multi fastener rack 108 is supported on a transverse rail 110 that runs the length of the cart 102 along the transverse axis, or perpendicular to the longitudinal axis. In some embodiments, the multi fastener rack 108 is movable (e.g., slidably, at intervals) along the transverse rail between installation cycles. The cart 102 also include a control system housing 112 (e.g., plastic, metal, rubber, wood) that may comprise various control systems, control circuitry, and power supplies, whether internally or externally, whether permanently or removably. The multi fastener rack 108 comprises a plurality of automated drills 114 for installing roofing fasteners (e.g., nails, screws). In some embodiments, as opposed to some prior-art systems using O-rings to maintain alignment of the fastener, the alignment of the plurality of fasteners is maintained by one or more springs.

An automated fastener feed system of the multi-head roofing fastener system 100 incorporates a loading rail for loading multiple drills 114 at once. An eccentric weight motor creates vibrations to allow the fasteners to move along this rail so that the individual drills 114 can be maintained and loaded. The loading rail has gates 116, which may be opened based on which individual drill 114 requires reloading. Once the gates 116 open, the fasteners can then pass through the gate and be held in a smaller cartridge, which can hold up to ten fasteners at once, although this amount of fasteners can vary, whether less than ten (e.g., 9, 8, 7, 6, 5, 4, 3, 2, 1) or greater than ten (e.g., 11, 12, 13, 14, 15, 16, 17, 18, 19, 20, tens, hundreds). From this cartridge, a new fastener is loaded during the upward motion of the drilling system by means of a pin located on the vertical actuation system, ensuring that only one screw is in the chamber at any point in time (although more than one fastener can be positioned in the chamber in other embodiments).

To address the issue of improper torqueing, aligning the cart 102 along the ribs of the sheet metal underneath the insulation board is the first step. If the insulation is installed properly, when the fasteners are screwed down, they will hit the top part of the rib due to the proper alignment of the board with the sheet metal decking. After ensuring the proper alignment, the second step is based upon the hall sensors (or other forms of suitable sensors) found on the brushless (or brushed) DC (or AC) motor (or another mover) of the drills 114. The readings, speed, and torque of the motor (or another mover) can be calculated form the hall effect motor (or another form of mover).

The various drills 114 of the multi-head fastening system 100 move (e.g., laterally) in sync (or asynchronously) to various positions, whether preset or no, so as one fastening is being completed the drill will raise and move to the next row of installations. It is at this point that the operator will be able to view the last region in which the fastener was installed, facilitating visual inspection without the need of manually moving the entire assembly.

Various servo motors (or other movers) provide functionality and directional mobility to the fasteners in a horizontal and vertical motion. In some embodiments, each individual fastener has a servo motor (or another form of mover) to provide vertical motion and the multi fastener rack is served by one or more motors (brushed or brushless) to provide horizontal motion along the transverse rail 110.

A control panel 112 may be included with the cart 102, or alternatively a remote control panel (wired, waveguide, or wireless) may be provided. In some embodiments, the control system may incorporate multiple Raspberry PI units (or controllers or circuit boards or other forms of hardware or software logic) operated by a Raspberry control touchscreen (or controllers or circuit boards or user input devices or other forms of hardware or software logic). For example, the Raspberry PI units can be Pi1, Pi2, Pi3, Pi4, or others. The Raspberry touch screen will send commands to the multiple Raspberry Pi units, which will then controllably operate the drills 114 (wired or wirelessly) to install a set pattern of fasteners. In some embodiments, not all drills 114 or fasteners are activated simultaneously, but instead are operated to match a preselected installation pattern, whether open shaped or closed shape, whether symmetrical or asymmetrical. In one embodiment, a maximum of four drills 116 out of seven are operated at any one time.

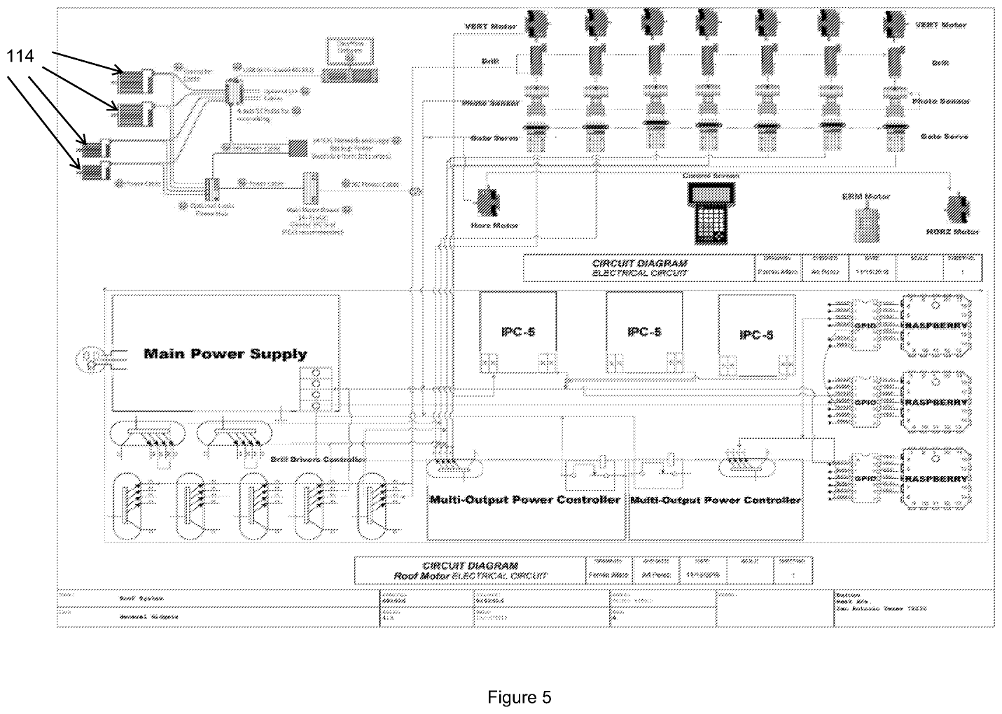

As shown in FIG. 5, embodiments of this disclosure may further comprise photo-sensors, gate servo motors, and ERM motors that may be operably coupled to the Raspberry PI units (e.g., wired, wireless) and that will facilitate the fastener or drill functionality.

In operation, a single operator can install a selected pattern of fasteners on a roof, such as a flat/level roof, by initiating an installation program through a controller on the cart 102 and moving the cart 102 from one location to another on the roof, or have the cart 102 automatically movably follow the single operator (e.g., based on wireless beacon on the single operator), or have the cart 102 move based on various environmental input (e.g., computer vision, radar, LIDAR, ultrasonic sensors) or have the cart 102 move based on a preprogrammed roofing map stored on the controller. The selected pattern of fasteners can be open shaped or closed shape, whether symmetrical or asymmetrical. Various additional details of the present invention are set forth in the figures presented herein.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, then there are no intervening elements present.

Various terminology used herein is for describing particular example embodiments and is not intended to be necessarily limiting of this disclosure. As used herein, various singular forms “a,” “an” and “the” are intended to include various plural forms as well, unless specific context clearly indicates otherwise. Various terms “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/−10% variation from a nominal value/term. Such variation is always included in any given value/term provided herein, whether or not such variation is specifically referred thereto.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features described with respect to certain example embodiments can be combined and sub-combined in and/or with various other example embodiments. Also, different aspects and/or elements of example embodiments, as disclosed herein, can be combined and sub-combined in a similar manner as well. Further, some example embodiments, whether individually and/or collectively, can be components of a larger system, wherein other procedures can take precedence over and/or otherwise modify their application. Additionally, a number of steps can be required before, after, and/or concurrently with example embodiments, as disclosed herein. Note that any and/or all methods and/or processes, at least as disclosed herein, can be at least partially performed via at least one entity in any manner.

Example embodiments of this disclosure are described herein with reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Various corresponding structures, materials, acts, and equivalents of all means or step plus function elements in various claims below are intended to include any structure, material, or act for performing the function in combination with other claimed elements as specifically claimed. Various embodiments were chosen and described in order to best explain various principles of this disclosure and various practical applications thereof, and to enable others of ordinary skill in a pertinent art to understand this disclosure for various embodiments with various modifications as are suited to a particular use contemplated.

This detailed description has been presented for various purposes of illustration and description, but is not intended to be fully exhaustive and/or limited to this disclosure in various forms disclosed. Many modifications and variations in techniques and structures will be apparent to those of ordinary skill in an art without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

Although preferred embodiments have been depicted and described in detail herein, skilled artisans know that various modifications, additions, substitutions and the like can be made without departing from spirit of this disclosure. As such, these are considered to be within the scope of the disclosure, as defined in the following claims.

What is claimed is:

1. A multi-head fastening device comprising:
a chassis comprising;
a frame having a longitudinal and transverse axis:
a plurality of wheels secured to the frame;
a transverse rail movable relative to the frame;
a plurality of automated fastening heads mounted to the movable rail; each fastening head configured to automatically install a fastener to a substrate below the chassis and further configured to move vertically;
a fastener loading mechanism; and
a control system for activating the plurality of fastener heads.

2. The device of claim 1 further comprising a first servo motor for moving the transverse rail and a second servo motor for moving the plurality of fastening heads.

3. The device of claim 2 wherein the second servo motor comprises a plurality of servo motors.

4. The device of claim 1 wherein each of the plurality of fastening heads has dedicated servo motor and is configured to move independently from any other fastening head.

5. The device of claim 1 further configured with a plurality of servo motors to actuate movement of the transverse rail relative to the longitudinal axis of the frame and to actuate movement of each of the plurality of fastener heads vertically from a plane defined by the longitudinal and transverse axis of the frame.

6. The device of claim 1 further configured with an actuator to feed fasteners into each of the plurality of the fastener heads.

7. The device of claim 1 wherein the control system is configured to actuate two or more fastener heads simultaneously.

8. The device of claim 1 wherein the control system is configured to actuate two or more fastener heads independently.

9. The device of claim 1 wherein the control system is configured to actuate at least three fastener heads simultaneously in a first installation and to actuate at least two fastener heads in a second installation.

10. The device of claim 1 further comprising a photo sensor for determining the position of the plurality of fastener heads.

11. A system for installing multiple fasteners to a substrate comprising:
a chassis having a frame and a transverse member;
a plurality of fastener heads mounted to the transverse member;
a fastener feed system;
a fastener head actuator to move two or more fastener heads in simultaneous movement;
a control system comprising a processor configured to control movement of the fastener head actuator.

12. A method of installing multiple fasteners to a substrate comprising:
providing an multi-head fastening device comprising:
a frame having a longitudinal and transverse axis:
a plurality of wheels secured to the frame;
a transverse rail movable relative to the frame;
a plurality of automated fastening heads mounted to the movable rail; each fastening head configured to automatically install a fastener to a substrate below the chassis and further configured to move vertically;
a fastener loading mechanism; and
a control system for activating the plurality of fastener heads.
activating a first sequence wherein the control system causes a first set of the plurality of fastening heads to install multiple fasteners to a substrate at a first location, and
activating a second sequence wherein the control system causes a second set of the plurality of fastening heads to install multiple fasteners to a substrate at a second location.
